(19) United States
(12) Patent Application Publication
(10) Pub. No.: US 2004/0018847 A1
(43) Pub. Date: Jan. 29, 2004

(54) Method for receiver-nonspecific publication of location-sensitive short message service messages

(76) Inventor: Jane Peng-Zi Chang, Chapel Hill, NC (US)

Correspondence Address: Jane Peng-Zi Chang, 104 Sierra Dr., Chapel Hill, NC, 27514, US

(21) Appl. No.: 10/202,357

(22) Filed: Jul. 24, 2002

(51) Int. Cl. H04Q 7/20

(52) U.S. Cl. 455/466

(57) ABSTRACT

The present invention intends to transform Short Message Service (SMS) messages into a commercially viable medium on which bulk amount of information can be disseminated. To achieve this objective, a system is disclosed to publish location-sensitive SMS messages to groups of non-predetermined receivers. This system embodies functionality to accompany the full cycles of the SMS message distribution, from creation, through processing, until publication. It leverages existing wireless infrastructure and the Internet establishment. Based on the present invention, new commercial services can be developed, such as real-time yellow-page services over wireless spectrum.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

The present invention relates to the field of wireless messaging. In particular, the present invention discloses a method to publish location-sensitive Short Messages Service (SMS) messages to non-predetermined groups of receivers.

### BACKGROUND OF THE INVENTION

The Short Message Service (SMS) is a globally accepted wireless service that enables the transmissions of alphanumeric messages among mobile devices (e.g., cell phones) and external systems such as electronic mail, paging and voice-mail systems. Current SMS infrastructure transmits SMS messages to specific end-points (destinations) through proprietary telephony and wireless networks. It provides advance features such as alerts and guarantee of delivery.

To send a SMS message, a user first writes one, and specifies the intended receivers of the message. The receiver addresses are given in the form of cell phone numbers, email addresses, or some other formats. The addresses must be provided before message transmissions are possible. In other words, destination addresses are specific in the sense that they must be defined individually and in advance before the SMS infrastructure attempts any deliveries. For example, if you were sending a SMS message to your friends Adam and Bob on your cellular phone, you need to key in their respective cell phone numbers when composing the message. Only after that is your message submitted into the SMS backbone for transmission. The SMS infrastructure 1) transports SMS messages in receiver-specific manners, and 2) requires message destinations being set in advance during the creation phases. Notice, the time at which a message is bound to its destinations is very early with respect to the message's publication lifetime. Let's characterize it as “early destination binding”.

SMS message based applications have been introduced as the SMS becomes increasingly popular. Nevertheless, the current SMS usage pattern and infrastructure exhibit a number of disadvantages when it comes to delivering commercial SMS messages in bulk volume.

Receiver Specificity And Early Destination Binding

The characteristics of receiver specificity and early destination binding preclude information from being distributed to arbitrary audiences. While they are suited for exchanging personal messages, they do not best capture the requirements of distributing commercial messages in bulk volume at large scales. Commercial messages are intended for large-scale distribution so as to reach a broad number of audiences. For instance, advertisements in today's mass media (e.g., TVs and magazines) are one type of commercial message. They are receiver non-specific in that it is not necessary to know which individuals would read and consume them at the time of composition (Of course, they need to understand the demographic compositions of their audience group as a whole, but not on an individual level). Similarly, these advertisements adopt late destination binding in the sense that their audiences are only identified and bound at the time of TV airing, and magazine selling. Unfortunately, these are the very qualities the current unicast SMS messages do not furbish.

To achieve large-scale distribution of commercial SMS messages, it might be possible to associate multiple receivers to a network broadcast or a network multicast address. Network-wide broadcast lacks selectivity on published SMS messages. Whereas, the usage paradigm for network-wide multicast would remain receiver specific and adopt early destination binding. Unless membership can vary dynamically for a given multicast address, the ultimate destinations are specific, therefore not arbitrary, with respect to the multicast address. In all scenarios, the addresses are always required a priori. (Note, the broadcast and multicast in this context refer to broadcasting and multicasting over entire carrier network or networks. They are different from broadcasting and multicasting within a confined wireless cell.)

The properties of receiver specificity and early destination binding are innate qualities of the current SMS message usage patterns. They prevent the SMS messages from becoming a commercially viable medium on which bulk volume of information can be disseminated.

Location Insensitivity

SMS messages are often displayed on mobile devices (e.g., cell phones). As far as their commercial uses, it would be effective to display location sensitive data by taking advantage of the mobility offered by the mobile terminals. For instance, while you are walking into a shopping plaza with your cell phone, it would be more relevant for you to see SMS messages displayed on your cell phone which inform you about the ongoing sales in the plaza; On the other hand, while you are in an airport terminal, real-time flight information of the neighboring airlines would most likely be of interests to you. SMS messages can be categorized and localized, so that yellow page services can be provided over the air to cover various locations. These SMS message yellow page (and advertisement) services are inherently more real-time, more dynamic, more wireless, more mobile, and more location sensitive.

The current SMS infrastructure is generic in that it facilitates SMS message transmissions from one place to another, anywhere in networks. Yet it fails to capture the location sensitivity natures of commercial messages. For example, SMS messages are often centrally stored and traverse through proprietary telephony and wireless networks for every delivery attempt. Consequently, the current SMS infrastructure incurs higher costs and suffers from lower performance throughputs when it comes to transporting location sensitive messages.

Overheads

The current SMS infrastructure provides many advanced features, such as guaranteed message delivery, at the cost of consuming more network resources. Incidentally, some of the features might be overkill in the case of delivering commercial SMS messages. Generally, it would be all right if audiences missed one or two commercial SMS messages. Considering the network resources consumed, the values of these advanced features become questionable in the case of distributing commercial messages.

### BACKGROUND OF THE INVENTION—OBJECTS AND ADVANTAGES

The main object of the present invention is to transform the SMS messages into a medium suitable for large-scale distribution of commercial information. The invention facilitates one-to-many publication of SMS messages, and offers advantages such as:

enabling of late destination binding so as to dynamically discover larger groups of audiences;

capturing location sensitivity of SMS message contents so as to provide audiences with relevant information;

classifying SMS message contents so as to provide audiences with organized information accesses;

efficient delivery of commercial SMS end-to-end.

Further objects and advantages of the invention will become apparent from a consideration of the drawings and ensuing description.

### SUMMARY

In accordance with the present invention, a sample embodiment is devised. This system captures the requirement of location sensitivity on commercial SMS messages; it delivers SMS messages in a receiver non-specific manner, and adopts late destination binding so as to reach a wide number of audiences; it opportunistically publishes SMS messages so as to avoid unnecessary overheads. The system can either be implemented as an addition to the current SMS infrastructure, or it can operate independently as a standalone messaging apparatus.

The system logically comprises a number of components. The components inter-operate with one another. Collectively, they embody the full cycle of commercial SMS message publications, from creation, through process, until publication. The system exhibits many advantages and characteristics.

### DRAWINGS—FIGURES

The disclosed inventions will be described with reference to the accompanying drawings, which show the sample embodiment of the invention and which are incorporated in the specification hereof by reference. Parts in the drawings are conceptual. They may be illustrated as integral entities in the diagrams, yet could be implemented as many discrete pieces distributed across distinct locations in actual embodiments.

FIG. 1 is a schematic overview of the system, its components, and its interactions with external worlds.

FIG. 2 illustrates the Publication component's spike-like topology.

FIG. 3 depicts the conceptual structure of a Publication branch component.

FIG. 4 shows a multi-tier chain forming a conceptually integrated Publication branch component.

FIG. 5 depicts the double-buffering mechanism implemented in Publication branch component tiers.

FIG. 6 illustrates an additional embodiment of the invention, where SMS messages are published to output targets other than mobile devices.

### DRAWINGS—Reference Numerals

Like numerals refer to like parts throughout the drawings.

10 Sample system that embodies the present invention

12 Message Creation & Collection component

12′ Expanded Message Creation & Collection component to support publication methods

14 Message Repository & Analysis Component

14′ Expanded Message Repository & Analysis Component to support publication methods

16 Message Publication Component

16′ Expanded Message Publication Component to support publication methods

18 Message input sources

20 Message output targets

20′ Expanded Message output targets

22 Publication branch component

24b, 24c, 24d Coverage location

26 Buffer

28 Front-end

30 Tier

32 Chain

34 Counter data structure

34a Current buffer pointer of the Counter data structure

34b Next buffer pointer of the Counter data structure

### DETAILED DESCRIPTION OF THE PREFERRED EMBODIMENT

Notation and Nomenclature

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention. For example, the present invention has been described with reference to the global Internet. However, the same techniques can easily be applied to other networks.

The detailed description of the present invention in the following is presented largely in terms of procedures, steps, logic blocks, processing, and other symbolic representations that resemble data processing devices coupled to networks. These process descriptions and representations are the means used by those experienced or skilled in the art to most effectively convey the substance of their work to others skilled in the art. The method of the present invention along with the apparatus to be described in detail below is a self-consistent sequence of processes or steps leading to a desired result. These steps or processes are those requiring physical manipulations of physical quantities. Usually, though not necessarily, these quantities may take the form of electrical signals capable of being stored, transferred, combined, compared, displayed and otherwise manipulated in a computer system or electronic computing devices. It proves convenient at times, principally for reasons of common usage, to refer to these signals as bits, values, elements, symbols, operations, messages, terms, numbers, or the like. It should be borne in mind that all of these similar terms are to be associated with the appropriate physical quantities and are merely convenient labels applied to these quantities. Unless specifically stated otherwise as apparent from the following description, it is appreciated that throughout the present invention, discussions utilizing terms such as “processing” or “computing” or “verifying” or “displaying” or the like, refer to the actions and processes of a computing device that manipulates and transforms data represented as physical quantities within the computing device's registers and memories into other data similarly represented as physical quantities within the computing device or other electronic devices.

Functional Components

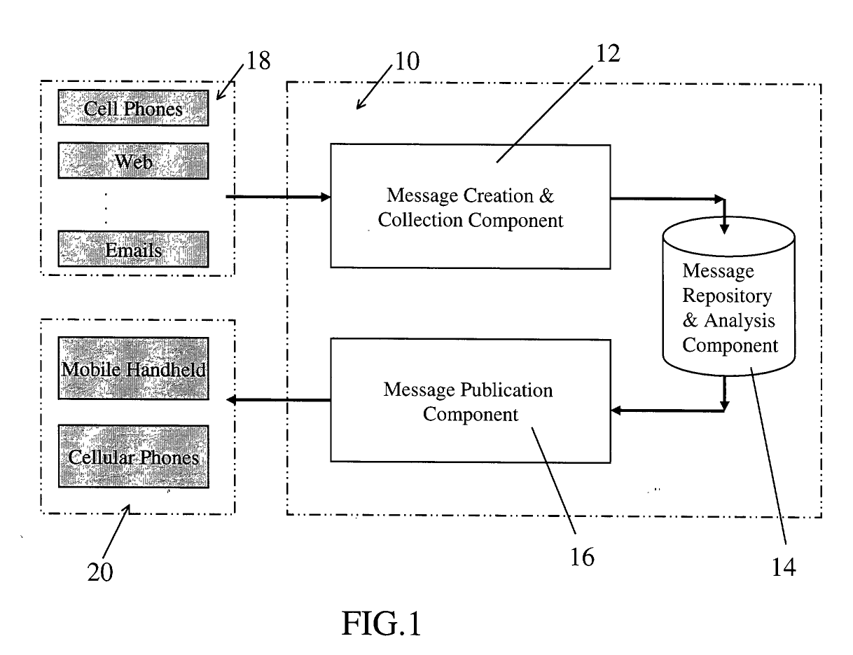

Referring now to drawings, FIG. 1 gives a schematic overview in which the present invention may be practiced. Sample embodiment system is referenced by numeral 10 in the figure. The system 10 comprises three functional components: Message Creation & Collection Component, Message Repository & Analysis Component, and Message Publication Component.

The Message Creation & Collection Component is referenced by numeral 12 in FIG. 1. It interfaces with SMS message input sources marked as 18. The message input sources 18 could take a variety of forms so long as they serve as input origins from which SMS messages flow into the Message Creation & Collection Component 12. FIG. 1 illustrates the diverse forms of the message input sources 18 by including Cell Phones, Web, Emails, etc. as parts of their composition. Depending on the specific forms of message input sources, the Message Creation & Collection Component 12 may interconnect with them in different ways. For example, in the case of Web based input sources, users may browse HTML pages generated by the Message Creation & Collection Component 12 through the global Internet. The users may then specify SMS messages through these HTML pages. On the other hand, if the input sources are of Email types, users may compose emails, from which the Message Creation & Collection Component 12 subsequently extracts for SMS messages.

Referenced by 14 is the Message Repository & Analysis Component in FIG. 1. It interconnects with the Message Creation & Collection Component 12 to facilitate overall functioning of system 10. The interconnection can be realized in many ways depending on specific embodiments. For instance, suppose the Message Repository & Analysis Component 14 is made of a Database management system and the Message Creation & Collection Component 12 is built upon Java technology, JDBC connections may be of a logic choice for the interconnection. Again, other types of connections are conceivable in different circumstances without departing from the essences of the present invention.

The Message Publication Component is referenced by numeral 16 in FIG. 1. On the one hand, the component couples with the Message Repository & Analysis Component 14; on the other hand, it interfaces with the SMS message output targets marked as 20. For the convenience of naming, its coupling to the Message Repository & Analysis Component 14 is denoted as back-end operations, while its interfacing with the SMS message output targets 20 is described as front-end functions. Interconnections, between components 14 and 16, shall be established to facilitate back-end operations. The interconnections can be achieved in many ways depending on specific embodiments. For example, JDBC connections may be of reasonable candidates for certain implementations. On the front-end, the SMS message output targets 20 generally comprise a plurality of forms so long as they act as receptive outlets to which SMS messages are published and displayed. FIG. 1 illustrates the multitude of forms of the message output targets 20 by including Mobile Handheld, Cellular Phones, etc. as parts of their composition. Depending on the specific forms of message output targets, the Message Publication Component 16 may interconnect with them in different ways. For example, in the case of cellular phone based output targets, the Message Publication Component 16 could transmit SMS messages to the mobile devices through wireless networks.

SMS messages flow throughout the system 10 in the directions indicated by the arrowheads in FIG. 1. Messages originally enter the Message Creation & Collection Component 12 from the input sources 18. They are then forwarded to the Message Repository & Analysis Component 14 for storage. The SMS messages are eventually propagated to their desired output targets 20 after being processed by the Message Publication Component 16. Thereby the Message Repository & Analysis Component 14 is effectively a connector that couples the Message Creation & Collection Component 12 with the Message Publication Component 16.

Given the above structural overview of the system 10, we now examine functionality and internal structure of each component in more depth.

Message Creation & Collection Component

The Message Creation & Collection Component 12 realizes the functionality of either creating new SMS messages, or collecting them from third party systems if they have already existed there. During the creation and collection phase of a SMS message, its contents are specified. The SMS message is additionally accompanied with a set of auxiliary data, which includes the message's classifications, publication schedules, and designated publication locations. The set of auxiliary data is used to assist the processing and publication of the SMS message. For example, the system 10 will classify the message under its given categories and distribute it within the designated locations during the specified time periods. The component 12 can be implemented in a variety of forms in accordance with the present invention. One possibility is a HTML based Web application; another is a set of API (Application Programming Interface) so as to expose the component's operations to the third party systems for data integration.

Message Repository & Analysis Component

Once messages are created or collected, they are persisted and analyzed by the Message Repository & Analysis Component 14 before being propagated to the Publication Component 16 for distribution. The Message Repository & Analysis Component serves as an linkage between the Creation & Collection Component 14 and the Publication Component 16. It analyzes all SMS messages and their auxiliary data to extract location sensitive information. The SMS messages are subsequently stored in the ways, which conveniently facilitate their future publications in designated locations in accordance to their schedules.

To facilitate message storage and analysis, the component 14 provides a data model to capture all data necessary for the operations in the Creation & Collection and the Publication components. Manipulations of the data model can be achieved through defined procedures. The component 14 can be implemented in a variety of forms in accordance with the present invention. One such possibility is to use relational database management systems.

Message Publication Component

Overall Network Topology

The Publication Component 16 is responsible for publishing location sensitive SMS messages in their designated locations based on respective schedules. It generally comprises a plurality of constituent branching components, denoted as Publication branch components. Each of the Publication branch components services one single location. Collectively, they cover a multitude of locations by forming a spike-like topology.

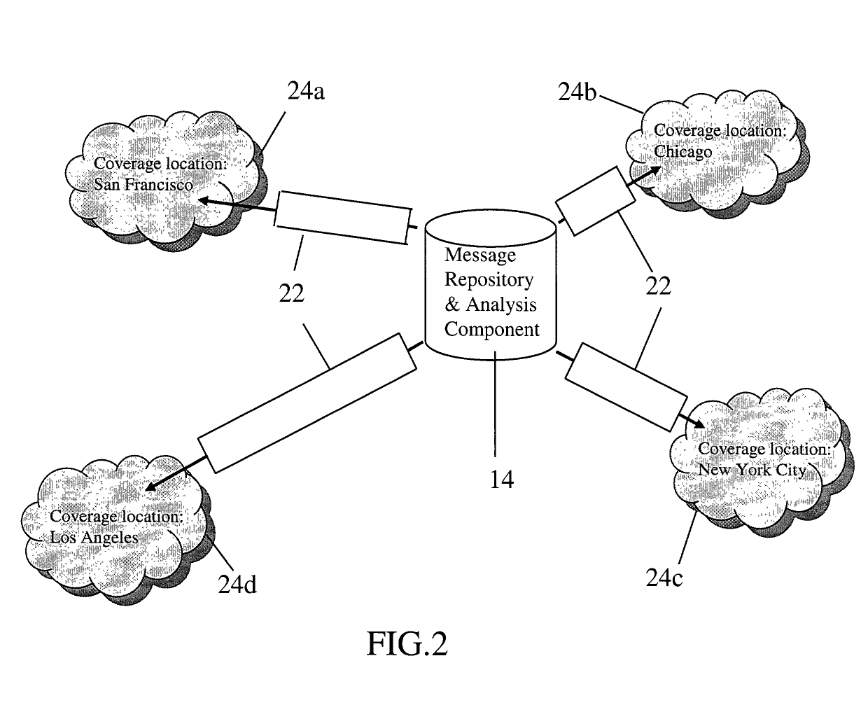

FIG. 2 illustrates the spike-like topology of an overall Publication Component. The Message Repository & Analysis Component 14 situates in the center of the diagram. It stores all SMS messages to be published. Referenced by 22 are a number of Publication branch components. They service SMS messages to their coverage locations (24a, 24b, 24c, and 24d respectively) by transmitting messages in the directions marked by the arrowheads. In the embodiment as depicted by FIG. 2, the four Publication branch components 22 together constitute a Publication Component; The spike-like topology is effectively a location sensitive configuration to distribute messages. It reflects the very location sensitive natures of the SMS messages being published. Coverage locations (24a, 24b, 24c, and 24d) within the spike-like topology operate independently in that they are serviced with their own set of SMS messages in accordance with their local schedules. On the other hand, it is also possible for distinct locations sharing a same message if so specified during the message's creation.

Branch Component Tasks

In order to publish SMS messages to a designated location, each Publication branch component 22 entails 1) the back-end task of extracting relevant SMS messages from the Repository & Analysis Component 14, and 2) the front-end functionality of pushing them onto arbitrary mobile devices within its coverage location.

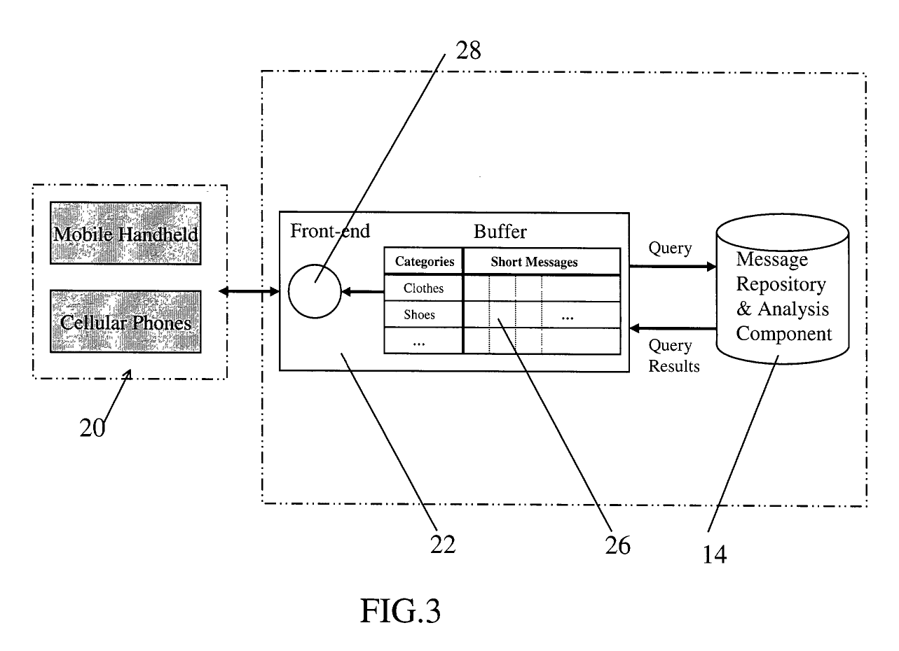

FIG. 3 depicts the conceptual structure to fulfill these tasks in a single Publication branch component 22. The Message Repository & Analysis Component 14 situates at the far right hand side in the diagram. It contains all SMS messages to be published. The Publication branch component 22 proceeds its back-end operations by launching queries on the Message Repository and Analysis Component 14, and extracts qualified SMS messages as query results. The extracted SMS messages are stored temporarily in buffer 26. Referenced by 28 is the front-end portion of the Publication branch component 22. In order for the front-end 28 to publish the SMS messages in buffer 26, it needs to interface with all mobile devices 20 in its single coverage area. Specifically, the front-end 28 constantly monitors its designated area, so that it can detect any entering and exiting mobile devices 20. For devices 20 inside the coverage area, the front-end 28 selectively pushes messages downstream onto them, and the front-end 28 also reacts upon upstream requests from the devices 20 as their users making selection on them.

Interface With Mobile Devices

Conceptually, the interfacing between the front-end 28 and mobile devices 20 can be achieved in similar ways as these in today's cellular technologies (regardless whether they are based on GSM, CDMA, or TDMA standards). In the current wireless networks, there are Base Station Systems (BS) installed at various locations to service areas, known as cells. The primary function of the BS is to transmit electromagnetic radio signals between wireless backbones and the mobile devices within its cells. The front-end 28 can utilize the BS to interface with mobile devices by coupling with them. Namely, the BS performs an additional role of relaying downstream SMS messages and upstream requests back and forth between the Publication branch components 22 and the mobile devices 20 in its coverage areas. Of course, it remains cohesive to the present invention if the Publication branch components 22 take advantage of other technologies to interact with mobile devices.

It is worth it to note that the time at which a Publication branch component 22 interacts with mobile users in its coverage areas is the time at which SMS messages actually bind to their audiences. Namely the time of destination binding is procrastinated all the way to the very last stage of the messages' publication lifetimes. In contrast to that of the current SMS usage model, the present invention successfully achieves late destination binding.

Profiles

The mechanism of profiling is employed in the Publication branch components 22 to intelligently interact with mobile devices. Ultimately, it attains the objectives of maximizing relevant SMS messages and minimizing irrelevant information distributed to mobile devices 20. By keeping track of interaction histories, the Publication branch components 22 establish profiles for all their mobile devices and users. These profiles aid the Publication branch components 22 to sift and filter out undesired messages for subsequent publications.

Profiles can be constructed based on per session interaction histories, or across session histories. They can be shared among various coverage locations in the spike-topology. They can reside on mobile devices (client side), or be built centrally in the Publication Component (server side). Each means offers different pros & cons.

Profiles also facilitate the content refreshment of SMS messages. It is possible to renew SMS messages to mobile devices in real-time, so that the mobile device users would be in touch with the latest information. Depending on whether profiles reside on the client sides or on the server sides, the content refreshment functionality can be implemented by client pulling or server pushing.

Responsiveness

For human users of mobile devices, it is interactive in nature as far as their experiences of interfacing the Publication branch components 22. For example, in one embodiment of the present invention, suppose a mobile user enters an area under the coverage of a Publication branch component 22, a menu could be automatically popped up on the user's cell phone. For the purpose of illustration, let's assume the menu contains selections of nearby restaurants, ongoing shoe sales, and etc. Once the user chooses the shoe sales from the menu by clicking on his or her cell phone. The Publication branch component 22 starts pushing downstream real-time information related to ongoing shoe sales in the location. Of course, the user may also turn off the menu, and thereby refuses further related SMS messages.

Responsiveness is of a high priority in the interaction scenario described above. A number of engineering techniques are devised. One of them is chaining; another is double buffering. The motivations and the details of the two techniques are elaborated below.

Chaining

Chaining is a technique employed to improve the responsiveness of the Publication branch components. It is particularly relevant in an operating environment such as the global Internet, where network traffic is routinely dropped, congested, and corrupted. On the other hand, it may not be as applicable if the network is less hostile and is capable of providing highly reliable and timely deliveries.

As discussed, the Publication branch component is responsible for fetching messages from its back-end and preparing them at the front-ends. It plays a role of bridging the back-end messages to the front-end mobile devices. In real deployment scenarios, the two ends are rarely located nearby one another in physical distance. This peculiarity in deployment topology gives rise to the question of where a Publication branch component should be physically implemented. There are a number of choices: 1) the Publication branch component can be built near the back-end; 2) it can be built close to the front-ends; or 3) it can be built to span across the entire physical distances from the back to the fronts.

There are different implications resulting from the choices made on this issue. The first choice, where the Publication branch component resides close to the back-end, resembles the popular deployment scenarios in the current Web. In this case, every request from mobile users has to voyage through entire networks and ultimately reach the back-end. This is non-responsive at least. Worse yet, location sensitivity of messages is not best captured in this topology. Uses of SMS messages can be expensive since requests traverse entire networks every time. In contrast, the second option resolves the issue. However, it would be unreliable and untimely for the Publication Component to fetch data from the back-end by journeying across unreliable networks.

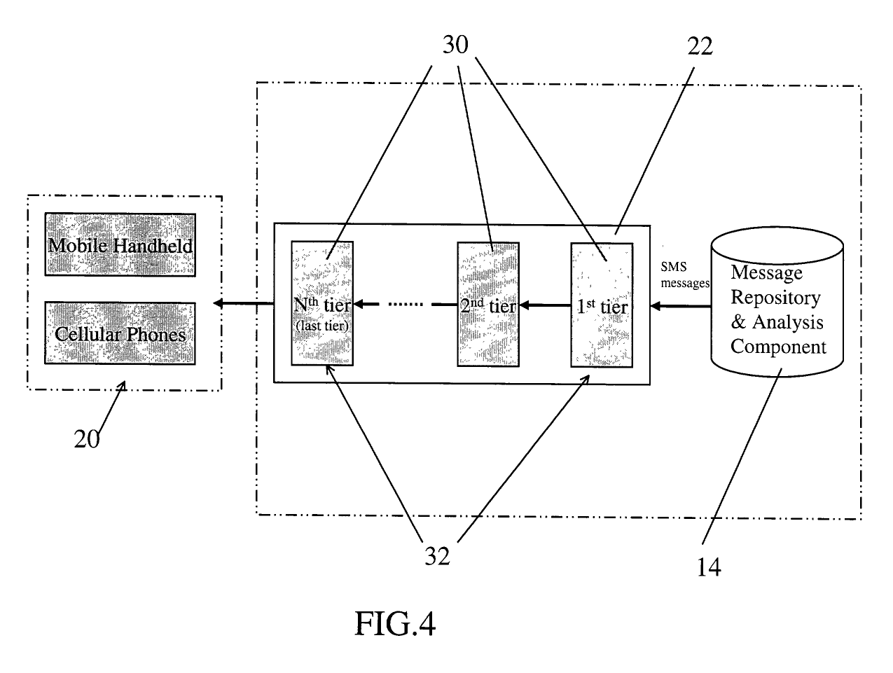

A N-tier chain as prescribed in the third option can address the dilenmma of the Publication branch component spanning across large physical distances, where N is greater than or equal to one. Shown in FIG. 4, situated in center is a conceptually integral Publication branch component 22. It internally comprises a series of tiers 30. The tiers 30 are implemented as processes residing on different computing machines in distinct locations. They are interconnected with one another through communication channels. Collectively tiers 30 formulate a chain 32, along which each tier 30 draws SMS messages from the one 30 behind. At the far right end of the diagram, the Message Repository & Analysis Component 14 serves as a back-end and stores all SMS messages. The chain 32 originates from the back-end and continues until the very front (namely, the last tier). SMS messages flow along the chain 32 one tier at a time, and ultimately reach the front-ends, which is closest to actual publication locations. The arrowheads shown in FIG. 4 illustrate the direction of the SMS message movement. Mobile devices 20 in a publication location, relying on the wireless infrastructure, contact the last tier 30 for desired SMS messages.

The N-tier chain structure reduces the embodiment system's dependency on networks. Instead of transmitting SMS messages via proprietary networks as that in the current SMS infrastructure, it is possible to implement a N-tier chain on the global Internet. This significantly lowers the capitol investment required for deployment.

It is an implementation issue as far as the specific means used to achieve the data traversal along chains. For example, an Nth tier could pull its ancestor (the N-1th tier) for data, or a N-1th tier could proactively push SMS messages onto its descendants (the Nth tiers). They differ from one another in terms of delivery efficiency, synchronization, and other properties.

Also, chaining does not preclude the uses of lower layer communication protocols to facilitate and enhance reliable transport. For instance, one possible implementation could be building the tiers on top of connection oriented and reliable TCP protocol.

Double Buffering

It is worth it to note that the contents of a Publication branch component are dynamic in the sense that there are distinct schedules associated with SMS messages. SMS messages are only available for mobile users' requests during their schedule periods. To further improve responsiveness, it would be beneficial for the Publication branch component to buffer SMS messages ahead of their publication schedules. As a result, messages are always ready at the front-ends of the Publication branch component as mobile users making their requests.

This is realized by applying the technique of double buffering. Namely, there are at least two buffers residing in the last tier of a Publication branch component. While SMS messages are serviced from one buffer (called the current buffer), the other buffers (called the next buffers) are filled and prepared with future messages.

The buffers are shuffled as time progresses. One of the next buffers becomes the up-to-date current buffer, while the previous current buffer is cleaned and ready for future messages (namely, it is demoted as one of the next buffers). New requests from mobile devices are always serviced from the newest current buffer.

The shuffling continues throughout the lifetime of the Publication branch component tier, so that SMS messages are always ready ahead of time. Possible communication failures can be overcome and remedied with ample amount of time.

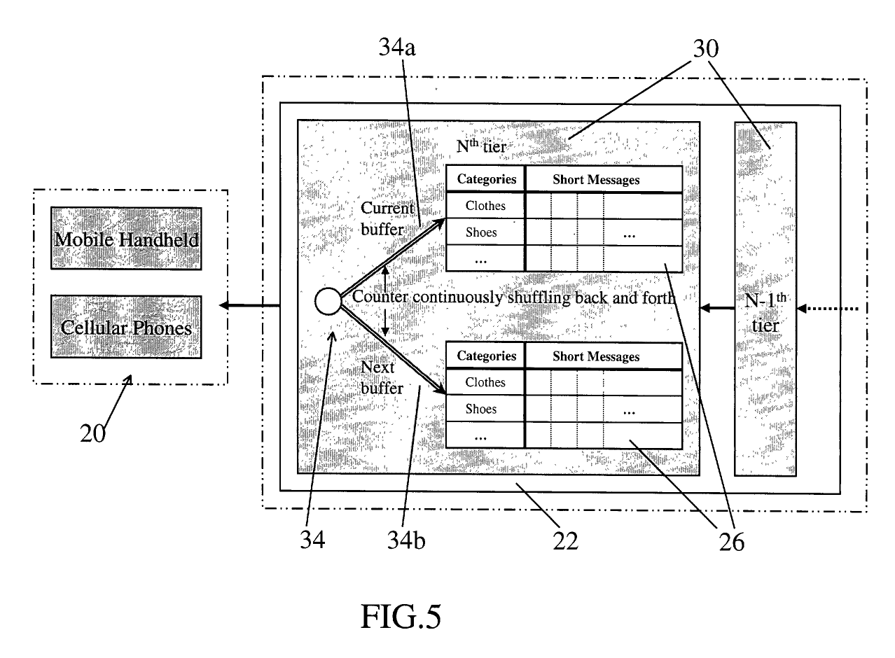

FIG. 5 depicts a specific implementation of the double-buffering mechanism. A Publication branch component 22 comprises a chain. Its Nth tier 30 (namely the last tier) contains two buffers 26. While the upper buffer 26 is designated as the current buffer for the time being, the lower buffer 26 is labeled as the next buffer. Both buffers 26 maintain identical message classifications because they all service a same publication location. Counter data structure 34 captures the shuffling behavior inside the Nth tier 30. It contains pointers (34a and 34b) to identify the current buffer and to differentiate it from the next buffer. Periodically the counter 34 swaps its pointers (34a and 34b) to reflect the latest buffer shuffling activities, while requests from mobile devices 20 are always satisfied from the current buffer. SMS messages flow in the directions indicated by the darkened arrowheads in FIG. 5.

FIG. 5 illustrates the concept of double-buffering in combination with the chaining technique. Yet the double-buffering mechanism can be implemented independently considering the case of a N-tier chain, where N equals one.

Operation of the Invention

This section further examines each component in the preferred embodiment, and gives detailed accounts on their respective operations. The system 10 is globalization ready in the sense that it supports different time zones, time formats, currencies, character encoding, and languages. As a result, the system is capable of deployment in regions around the World.

Message Creation & Collection Component

The Message Creation & Collection Component 12 realizes the functionality of either creating new SMS messages, or collecting them from third party systems if they have already existed there.

SMS messages created in this component 12 will be published in their designated locations under certain categories. For example, a user may create a SMS message, stating that all cellular phones will be on sale at the Best Buy store branches in San Francisco (SF) and New York City (NYC) areas on Sunday and Tuesday. The user may classify this message under the categories of appliances and wireless. In this example, the publication areas are San Francisco and New York City; the categories are appliances and wireless; Sunday and Tuesday are the publication schedules pertaining to the two locations. In other words, it is necessary to define locations, categories, schedules the system 10 supports before a SMS message can be meaningful created in this context. The locations, categories, and schedules constitute the very set of auxiliary data accompanying the creation of the SMS message. The Message Creation & Collection component 12 thereby supports at least the following operations—location configurations, category configurations, location and category associations, schedule definitions with respect to locations, and message creation and editing. Notice that the first four tasks are administrative with respect to the system. Generally, they are exposed to system administrators. The message creation and editing are functionality accessible for regular users. All operations can be exposed to and be manipulated by the third party systems through sets of API so as to facilitate the integration and collection of SMS messages. The locations, categories, schedules and SMS message contents are displayed or specified in languages and formats native to their users so as to support the globalization features.

Location Configurations

This operation defines all locations supported by the system, namely the designated areas where SMS messages can be published. Locations are related to one another in certain ways. For example, San Francisco could be configured as a subordinating location of the location California if so specified. A SMS message can be designated to multiple locations in the system 10. New locations can be added; existing locations can be removed; the relationships among locations can be updated and reconfigured. The system 10 provides capacities so that the modification histories on location related information are recorded, and changes can be traced back.

Category Configurations

This operation defines categories supported by the system 10. SMS messages created in the system 10 are classified under various categories, so that they would be published and accessible to users under these categories. In the above example, the Best Buy sale advertisement is classified under the appliances and wireless sections. During the periods of its publication schedules (namely Sunday and Tuesday), mobile users in proximity to the SF and NYC Best Buy stores will be able to receive the classified advertisement under the two categories.

Categories are related to one another in certain ways. For example, wireless could be configured as a subordinated category of the appliances. New categories can be added; existing ones can be removed; their relationships can be updated and reconfigured. The system 10 provides capacities to record modification histories and to roll them back.

Location and Category Associations

This operation defines the associations between categories and locations. At any given time, a location can support a finite set of categories, while a category may appear in several locations. For example, San Francisco may support categories such as computers, electronics and food (due to higher level of consumer interests for instance), whereas the location of Wisconsin may support categories such as cheese products, beef products and food. The system 10 provides capacities to add, update, and delete the associations. All modification histories are recorded and can be rolled back.

Schedule Definitions With Respect to Locations

Schedules are time periods in which SMS messages are designated for distribution in their publication locations. Schedules are significant with respect to their locations. The system 10 is globalization ready in that publication schedules are supported for different locations at various time zones with appropriate time formats across the World.

When users create SMS messages and specify their publication schedules, they are effectively making reservations of the time periods in the targeted areas. It is a configurable parameter as far as the maximal number of SMS messages the system 10 can accommodate in targeted areas during certain schedule periods. This parameter is dependent on factors such as system resources, delivery bandwidth, and mobile devices capacities.

There could be multiple publication schedules associated with a single SMS message. For example, the Best Buy advertisement mentioned can be aired on both Sunday and Tuesday.

Message Creation and Editing

This operation supports message creation, edits, and removal. In particular, the operations are multi-user enable so that message consistency is preserved while multiple users simultaneously manipulate the same message. There may also be authoring logic associated with the message creation, edits, and removal processes.

To create a SMS message, a user enters its message content. In addition, the user specifies its auxiliary data, including publication locations, schedules, and categories. At the end of the creation, the user receives a confirmation, which acknowledges the user actions that have just taken place. The confirmation also serves as a receipt, so that the user may retrieve the message later on by presenting it to the system 10.

Within a certain time frame, Users may continue editing their messages after their original creations. Editions can occur on any parts of the SMS messages, including changes on contents, schedules, locations, categories, and so forth. A serial of edits result in different versions of the same messages. The system 10 provides capacities to keep track of the versions and their logical association between each other. The content refreshment feature mentioned earlier is also facilitated through the message versioning.

Users may also remove their messages.

The system 10 is globalization-ready in that it may take SMS messages created in various languages and publishes them in appropriate languages relative to the destination sites. All modification histories are captured and can be rolled back if necessary. In addition, the system 10 is ready for API level data integration in that it exposes all its operations as sets of API.

Message Repository & Analysis Component

SMS messages are persisted and analyzed by the Message Repository & Analysis Component 14 once they have been created or collected. The Message Repository & Analysis Component 14 serves as a linkage between the Message Creation & Collection Component 12 and the Message Publication Component 16. The component 14 provides data model and manipulation procedures of the data model to fulfill the storage and analysis tasks.

In the particular case where this component 14 is implemented using relational database management systems, the data model is materialized as a set of entity and relation tables, whereas the procedures can be implemented as statements in a certain query language (e.g. SQL). When users create SMS messages in the Creation & Collection Component 12, new records are inserted into the various tables as the system 10 making invocations on appropriate procedures.

Data Model

Through the discussion on the Message Creation & Collection component 12, we have identified a number of data objects and the relations among them. These objects and relations are readily translated into schema tables in the data model. Combining the needs of the Message Publication component 16, the data model comprises location, category, schedule, confirmation, and SMS messages entities. It additionally comprises location category relation, and publication relation. The location category relation defines the association between locations and categories. The publication relation reflects the comprehensive relationships between SMS messages, their schedules, their confirmations, their categories, and their designated publication locations.

These entities and relation tables facilitate features such as message globalization, versioning, history tracking and rolling back, etc. For instance, while time schedules may be displayed in localized formats of distinct time zones in the Message Creation & Collection Component 12, they can be stored in a predetermined format with an uniform time zone in the Message Repository & Analysis Component 14.

Manipulation Procedures

Procedures are of two categories in functionality. One alters the state of data in the data model; the other queries them in accordance with certain criteria.

Procedures are called as events occur in the Message Creation & Collection component 12 and the Publication component 16. For example, the first category of procedures are executed to manipulate data in the database tables as users create, update, and remove SMS messages from the Creation & Collection component 12. Changes on administrative data, such as location, category, and schedules, also result in these procedures being called. On the other hand, The Publication component 16 extracts SMS messages for publication; it achieves the functionality through execution of the second category of procedures.

In all, both the data model and its manipulation procedures can be exposed to and be manipulated by the third party systems so as to enable schema level data integration.

Message Publication Component

The Publication Component 16 is responsible for publishing location sensitive SMS messages in their designated locations based on respective local schedules.

The system 10 is capable of servicing multiple locations as outlined in the spike-like topology discussion. For a given location, its Publication branch component 22 extracts qualified SMS messages from the back-end Repository & Analysis component 14 in time. The qualification is defined by the intended destination in combination with a publication schedule period, whereas the extraction is realized through invocations on the relevant manipulation procedures in the back-end Repository & Analysis component 14. As a result, appropriate SMS messages are selected into the Publication branch component 22.

The Publication branch component 22 continuously propagates its SMS messages towards their destination front-ends 28, where messages are prepared ahead of time for mobile users consumption. As discussed, the Publication branch component 22 can potentially span large physical distance from the back-end 14 to the front-ends 28. Messages in the branch component 22 travel through the distance so to reach their designated publication component front-ends 28. Mobile users, within the coverage of the front-ends 28, can then responsively access these SMS messages during their publication schedule periods. The message traversal can be achieved in various ways. The chaining technique is relevant under the circumstance of hostile networks.

The SMS messages preserve their category classifications in the Publication branch component 22. (Note, the classifications were originally specified in the Creation & Collection component 12, and were subsequently stored in the Repository & Analysis component 14). The front-ends 28 distribute menus of the categories onto mobile devices in their coverage areas through their couplings with the Base Station Systems in the wireless infrastructure. Once a user elects a category from the menu displayed on his or her mobile devices, a request is formulated. This request is relayed to its servicing publication component front-end 28. The front-end 28 reacts by selectively pushing SMS messages of the chosen category to the requesting mobile users. The mobile users may also turn off the menus at any time during their interactions.

The Publication component 16 continues the above operations as time progresses in all its branch components for various locations. SMS messages are serviced in their respective locations in real time manner.

Advantages and Key Characteristics

Given the above discussion on each component's structure and functionality, the sample embodiment system exhibits the following advantages and characteristics.

Receiver Non-Specificity And Later Destination Binding

It is imperative to achieve receiver non-specificity and late destination binding in order to transform SMS messages into a form of mass medium. The embodiment system accomplishes the requirements by separating message creation from destination binding. In the Message Creation & Collection Component 12, users compose SMS messages. Rather than specifying intended receivers of their messages, they define the target locations in which the messages will be distributed. The actual audiences of these messages are dynamically discovered and bound at a later time in the target locations.

Location Sensitivity

SMS messages published via the present invention are location sensitive, so as to leverage the mobility of the mobile devices on which they are displayed.

The system supports the property through a number of means:

1. Target publication locations are specified during the message creation phase;

2. SMS messages are stored in location sensitive manners in the Message Repository & Analysis Component 14;

3. SMS Messages are published in their designated locations at the appropriate time;

4. The spike-like topology of the Publication Component reflects the location sensitivity nature of the commercial SMS messages.

Location is of a logical concept within the context of the present invention. Neither does it necessarily correspond to geographic areas relative to the surface of the earth, nor does it absolutely coincide with cells defined by wireless infrastructure coverage areas. For instance, Washington, D.C. and Arlington, Va. are two geographically distinct places. However, if identical set of SMS messages should always be distributed in the two areas because of certain high-level user logic, it is plausible to define the two as a single logically inseparable location in the embodiment system. Similarly, one or more wireless cells, whether or not they are adjacent to one another, can be combined into a single coverage location, while multiple coverage locations can reside within a single wireless cell.

SMS Message Based

The information, processed and distributed by the invention, is embodied in the form of SMS messages. As such, it is text based and is limited in size, normally 160 characters or less depending on specific carrier networks. The SMS messages can be optionally accompanied by multimedia, such as images and ring tones. Multimedia is specified for a given SMS message during its creation and collection phase, and could be pushed to end mobile devices whenever appropriate.

The information in the present invention differs from arbitrary information presented in the Internet (the Web) in a number of ways. Firstly, arbitrary Web contents may or may not be suitable for publications and presentations as SMS messages; secondly, information on the Internet is identified as resources, and is accessible based on certain addressing schemes (e.g., URL and URI). A client, such as a browser situating anywhere on the Internet, can request resources by actively sending request messages embedded with the resources' addresses. Namely, the client initiates contacts while information passively awaits them. In contrast, information in the present invention is actively pushed towards its mobile clients. It propagates from the back-end to front-ends without any mobile user initiated requests. This information movement is possible because of the very location sensitive property congenital to the SMS messages discussed in this invention (note, information in the present invention can be addressable as well although the addresses are not used for message transmission); thirdly, the SMS messages in this invention are inherently location sensitive and time constraint, whereas the general information on the Internet may not be. The present invention is real-time in nature. Messages are distributed in their designated areas just in time with respect to the time constraints given during message creations.

Audience Oriented

It is feasible to distribute audience-oriented information using the present invention. As discussed, SMS messages processed by the embodiment system are not intended for specific receivers. Nevertheless, it is conceivable to devise audience-oriented messages by understanding the demographic composition in the messages' distribution areas. For example, suppose a non-profit organization is launching an “Anti-Drug” campaign to educate teenagers. In addition to spending millions of dollars on advertisements through TVs, radios, and magazines, the organization could deploy SMS messages as a distribution channel to reach teen audiences. On school grounds covered by the SMS message services as these proposed in the invention, targeted “Anti-Drug” messages can be disseminated. The SMS messages discussed in this invention represent a novel and effective medium to preach towards diverse populations right on their fingertips.

Interface With Mobile Devices

The present invention addresses issues related to message creation, processing, and publishing. Ultimately, the SMS messages in the embodiment system need to be pushed and displayed on mobile devices. It is paramount for the system to interface with mobile devices in the last miles of message publications. We propose to utilize the current wireless infrastructure to bridge them.

The present invention can accommodate various types of wireless technologies, via which the wireless infrastructure communicates with mobile devices. For example, it could be based on CDMA, GSM, or other wireless technologies. The SMS messages in the system are merely payloads riding on top of underlying wireless technologies. Further more, the present invention is operable to various communication manners through which the wireless infrastructure communicates with mobile devices. Broadcast, multicast, and unicast could be employed as communication paradigms within each publication area. They differ from one another in terms of delivery efficiency, message selectivity, and other properties.

Profiles

Profiles are used to assist the Publication Component to intelligently interact with mobile devices (or users) by keeping track of previous interaction histories.

Responsiveness

Responsiveness is a key performance factor to facilitate the interactions between mobile users and the embodiment system. Techniques, such as chaining and double buffering, are used to improve the system's responsiveness. Ultimately, it achieves ahead-of-time preparations of SMS messages right at their publication sites.

Minimal User Involvement

The users of mobile devices are the ultimate recipients of SMS messages. To be user friendly, the proposed SMS message services keep them minimally involved in entire usage scenarios. Though it is doable to automatically push SMS messages onto mobile devices without any user intervention, it would have overwhelmed mobile users with unsolicited and indiscriminate information. Instead, a menu would first pop up on mobile devices whenever the users entering an area covered by the proposed SMS message services. The menu contains a series of categories representing sorted information pertinent to the area. Upon making a selection from the categories, the user will receive more information relevant to that choice. It is also feasible for the users to turn off the menu so that no more information of any kind would be shown on their mobile devices. The menu and the information could be published and presented in the form of SMS messages. From the users' perspective, it is transparent as far as where the SMS messages could be located. Again, it is also conceivable to present the SMS messages in forms, other than the pop-up menu, without departure from the scope of the present invention.

Globalization

The embodiment system is globalization ready in that it supports multiple currencies, time zones, time formats and various languages.

Integration

The embodiment system supports integration with arbitrary third party systems by exposing its API and data model. It is possible for the third party systems to set up configuration and to propagate SMS messages by manipulating the API and data model.

Additional Embodiments

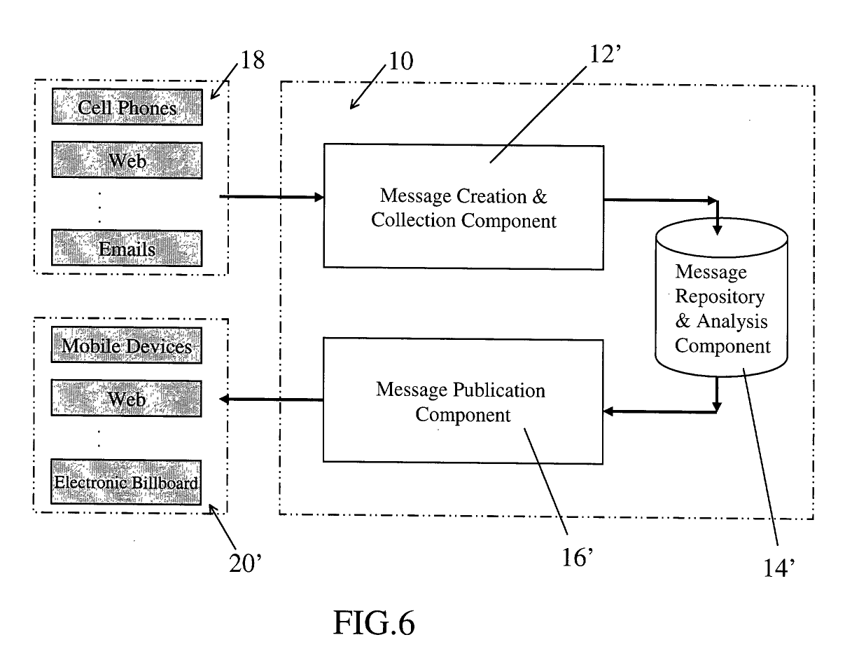

The present invention is sufficiently generic to embody SMS message output targets of many sorts. While it is the focus of the preferred embodiment to publish SMS messages to mobile devices, additional embodiments of the invention are possible to distribute SMS messages to other forms of destinations. FIG. 6 outlines the additional SMS messages output targets.

Referenced by 20′ in FIG. 6 is an expanded SMS message output targets. In addition to mobile devices, it incorporates other forms of destinations as message output targets, such as, Web and Electronic Billboards. To accommodate additional output targets, the system components need to be expanded accordingly. Referenced by 12′ is an expanded Message Creation & Collection Component. It inherits all functionality, characteristics, and operations of its counterpart 12 in the preferred embodiment. Furthermore, it introduces the concept of publication method to denote various forms of output targets. For example, suppose an embodiment system supports SMS messages distribution to mobile devices, billboards and Web, users of this system can then specify one or more publication methods associated with their messages as a part of the auxiliary data. One of the methods is mobile publication; another method is billboard publication; and the third method is Web publication. The modified Message Creation & Collection Component 12′ incorporates publication methods into its operations by allowing users to explicitly select desired publication output targets.

Referenced by 14′ is an augmented Message Repository & Analysis Component in FIG. 6. It captures the publication methods by additionally establishing new entity and relational tables into its existing data model. Manipulation procedures are expanded to operate on the publication method related data model.

Referenced by 16′ is an expanded Message Publication Component in FIG. 6. Various publication output targets may differ from one another substantially in their characteristics. For instance, the Web is capable of accessing information from anywhere and thus could obscure the location sensitivity of message distribution. The Message Publication Component 16′ is therefore tailored for each and every kind of publication method accordingly, while its overall functionality and operations remain unchanged.

As a result of the modifications, localized and classified SMS messages can be published on output targets of various sorts in real-time. SMS messages remain being organized and presented in a location sensitive manner.

Alternative Embodiments

While the present invention has been described with reference to an exemplary embodiment thereof, those skilled in the art will know of various changes in form and detail that may be made without departing from the spirit and scope of the claimed invention. Such changes may include, but not be limited to, different interfaces of the Message Creation & Collection Component, different modeling of the Message Repository & Analysis Component, different structures and deployments of the Message Publication Component, different interconnects among components, different ways to interface and interact with mobile users, and even different ways to architect the functionality and components.

For example, in one embodiment, it is imaginable to derive input SMS messages from 800 custom phone call services. Users may call designated 800 (or 888, 900, and etc.) phone call services, and request call agents to publish their information. In another embodiment, SMS messages and their relevant data can be organized in utilities other than relational database management systems. In other embodiments, SMS messages and their relevant data are transmitted through advanced, reliable, and proprietary networks so that much of discussions on double buffering, chaining, and spike-like topology may not apply. Yet in other embodiments, billing functionality can be added so as to collect revenues for the proposed SMS message services. Nevertheless, it is intended that all alterations and modifications be considered as within the spirit and scope of the invention as defined by the appended claims.

Conclusion, Ramifications, and Scope

Short Message Services (SMS) have represented the most astonishing growth in the wireless markets for the past years. Consumer and corporate applications based on SMS have been developed, yet none of them have broken off the early destination-binding paradigm. Consequently, it remains not practical to distribute large volume of commercial information via SMS messages. It is the intent of the present invention to challenge the status quo by transforming the SMS messages into a form of mass media.

It is anticipated that new business opportunities will stem from the invention. Particularly, there are three parties involved, network operators, vendors, and consumers. The network operators (e.g., AT&T, and Cingular) can expand their businesses by offering location-sensitive and real-time yellow page services over wireless spectrums. The new breed of services represent fresh sources of revenue, which ultimately boost the operators' bottom lines; For the vendors (e.g., the Best Buy, Wal-mart, airports and etc.), the SMS messages provide a novel channel through which they keep in touch with their customers. The SMS messages stand for an uncharted territory on which electronic commerce can tap in. Finally, for the consumers, it is hopeful that the SMS messages would become an inexpensive tool that make their everyday lives more convenient.

In addition, the invention harbors potential for integrating with third party systems. Presumably, the third party systems are enterprise software produced by software vendors such as the SAP, the PeopleSoft, and others. These enterprise software ameliorates corporate productivity by automating much of business processes. Enterprise software can deploy the SMS messages as a way to revolutionize traditional business into electronic business—the SMS messages can become prevalent platforms on which E-Commerce conducts, including marketing, selling, servicing, and etc. It is expected that integration of SMS with the enterprise software will come forth.

Although the description above contains many specificities, these should not be construed as limiting the scope of the invention but as merely providing illustrations for some of the embodiments of this inventions. Other variations are possible. Thus the scope of the invention should be determined by the appended claims and their legal equivalents, rather than by the examples given.

### DRAWING REFERENCE NUMERALS SHEET

### Part Name

10 Sample system that embodies the present invention

12 Message Creation & Collection component

12′ Expanded Message Creation & Collection component to support publication methods

14 Message Repository & Analysis Component

14′ Expanded Message Repository & Analysis Component to support publication methods

16 Message Publication Component

16′ Expanded Message Publication Component to support publication methods

18 Message input sources

20 Message output targets

20′ Expanded Message output targets

22 Publication branch component

24a Coverage location

24b Coverage location

24c Coverage location

24d Coverage location

26 Buffer

28 Front-end

30 Tier

32 Chain

34 Counter data structure

34a Current buffer pointer of the Counter data structure

34b Next buffer pointer of the Counter data structure

I claim:

1. A method of distributing SMS Messages to arbitrary recipients in a plurality of locations, comprising:
(a) entering a set of auxiliary data which specify said plurality of locations as the destinations to which said SMS messages are distributed,
(b) providing an input means for creating and collecting said SMS messages and said set of auxiliary data,
(c) providing an output means for distributing said SMS messages in accordance with said set of auxiliary data,
(d) providing a coupling means for operatively connecting said input means and said output means so as to facilitate said output means to extract said SMS messages from said input means,
whereby said SMS messages are ready for dissemination in said plurality of locations, and whereby said arbitrary recipients in said plurality of locations can access said SMS messages using two-way mobile devices, selected from a group including, mobile handheld, cellular phones, two-way pagers, pocket PC's, etc.

2. The method of claim 1 wherein said coupling means further include means for storing and retrieving said SMS messages and said set of auxiliary data, whereby said SMS messages are persisted overtime for publication.

3. The method of claim 1 wherein said set of auxiliary data further indicates a plurality of schedule periods during which said SMS messages are distributed, whereby said SMS messages are ready for dissemination in said plurality of locations during said plurality of schedule periods, and whereby said arbitrary recipients in said plurality of locations can access said SMS messages during said plurality of schedule periods using said two-way mobile devices.

4. The method of claim 3 wherein said set of auxiliary data further defines a plurality of categories under which said SMS messages are classified for ease of accesses, whereby said SMS messages are ready for dissemination in said plurality of locations during said plurality of schedule periods under said plurality of categories, and whereby said arbitrary recipients in said plurality of locations during said plurality of schedule periods can access said SMS messages in an organized manner under said plurality of categories using said two-way mobile devices.

5. The method of claim 1 wherein said input means further contain means for configuring administrative data, selected from a group including, locations, schedules, categories, and their associations, thereby said set of auxiliary data respectively draw their values from said administrative data.

6. The method of claim 1 wherein said output means further contain coverage means for covering said plurality of locations, all of which are serviced with said SMS messages.

7. The method of claim 6 wherein said coverage means further contain interaction means for preparing said SMS messages on-site and in-time so as to enable said arbitrary recipients to responsively access said SMS messages in said plurality of locations.

8. The method of claim 6 wherein said coverage means further incorporate profile means for enabling intelligent interaction between said coverage means and said arbitrary recipients in said plurality of locations by remembering their interaction histories.

9. The method of claim 6 wherein said coverage means further include interface means for coupling with wireless infrastructure in said plurality of locations so as to interact with said arbitrary recipients through said two-way mobile devices.

10. The method of claim 1 contains means to obviate said SMS messages from being bound to specific and predetermined targets during creation stage, so as to dynamically discover and to bind to a multitude of said arbitrary recipients in said plurality of locations during distribution stage.

11. The method of claim 1 contains means for associating multimedia materials with said SMS messages throughout their publication life cycles.

12. The method of claim 1 contains means for integrating with third party systems so as to configure and formulate said set of auxiliary data and said SMS messages.
